(19) United States
(12) Patent Application Publication
(10) Pub. No.: US 2014/0327427 A1
(43) Pub. Date: Nov. 6, 2014

(54) COATING DEFECT DETECTION APPARATUS AND METHOD FOR CUT-TO-LENGTH CATHETER SHAFTS

(71) Applicants: David L. Carroll, Branford, CT (US); Theodore P. Lane, Clinton, CT (US)

(72) Inventors: David L. Carroll, Branford, CT (US); Theodore P. Lane, Clinton, CT (US)

(73) Assignee: CLINTON INSTRUMENT COMPANY, Clinton, CT (US)

(21) Appl. No.: 14/174,175

(22) Filed: Feb. 6, 2014

Related U.S. Application Data
(60) Provisional application No. 61/818,995, filed on May 3, 2013.

(51) Int. Cl. G01N 27/00

(52) U.S. Cl. CPC G01N 27/00
USPC 324/71.1

(57) ABSTRACT

Detection of a coating defect on a catheter shaft, by imposing AC voltage between an electrode and a grounding tube, passing the catheter shaft through the grounding tube and through the hole of the electrode, monitoring the voltage between the electrode and the grounding tube, and detecting the coating defect, in case the amplitude of the monitored voltage drops below a threshold value. The electrode defines a hole, which opens from an infeed side of the electrode to an outfeed side of the electrode. A voltage supply provides the AC between the electrode and system ground. A fault detection circuit monitors the electrode. The grounding tube has an outer surface connected to system ground, and is coaxial with the electrode hole, an inward tube end proximate the hole and an outward tube end distal the hole.

### CROSS REFERENCE TO RELATED APPLICATIONS

The present application is a non-provisional of, and claims priority to, U.S. App. No. 61/818,995, filed May 3, 2013, and hereby incorporates herein by reference the disclosures thereof.

### BACKGROUND

1. Technical Field

The present invention relates to the manufacture of medical catheters, and, more particularly, to quality assurance of insulative coatings on medical catheters.

2. Discussion of Art

Medical catheters are increasingly complex devices to manufacture, often comprising a dozen or more precisely manufactured components that are assembled together. Typically, catheters are built on a shaft that often consists of a polymer layer coated onto inner and outer surfaces of a tubular metal braid or helical wire (hereafter, a “scaffold”). In order to economically obtain a controlled surface finish while maintaining dimensional tolerances, the polymer layer often is centerless ground. However, centerless grinding can expose or cause quality defects.

For example, after centerless grinding, segments of the scaffold can break and pierce through thinned portions of the polymer layer, posing a risk of injury to a patient. If concentricity is not well controlled, the polymer layer may even be entirely removed from portions of the scaffold. If these faults are not promptly identified, additional processing may be undertaken, only to have the finished catheter fail (or worse yet, pass) its final inspection, after considerable unnecessary investment of additional time and processing.

It is desirable to test catheter shafts to identify polymer layer defects as early as possible. Therefore, a conventional approach to quality testing is to conduct a dynamic dielectric proof test as shaft stock emerges from a continuous braiding-and-coating process. It is advantageous to conduct the dielectric proof test at this stage of manufacture because the metallic wires of the scaffold can be grounded via the process machinery ahead of the coating applicators, while a standard dielectric proofing voltage can be applied at the exterior polymer layer after the coating applicators. Typically, direct current (DC) voltage is applied by the proof tester in order to easily detect a voltage drop in case a coating defect is present.

However, centerless grinding typically occurs after the stock shaft has been cut to length. This sequencing means that the defects addressed by the instant invention, occur after the conventional dielectric proof test. Additionally, because the stock shaft already has received an insulative coating and has been cut to length, it is no longer convenient to ground the scaffold via process machinery. The inconvenience of directly grounding the scaffold makes it impractical and infeasible to use conventional spark testing equipment.

### BRIEF DESCRIPTION

According to the present invention, a catheter tester is provided for reliable high voltage dielectric testing of cut-to-length catheter shafts, without requiring direct grounding of the shaft scaffolds.

In an exemplary embodiment, a catheter coating fault detection apparatus comprises an electrode, a voltage supply, a fault detection circuit, a grounding tube, and a case. The electrode that has infeed and outfeed sides and defines a hole, which opens from the infeed side to the outfeed side. The voltage supply is electrically connected to provide an alternating voltage between the electrode and a system ground. The fault detection circuit is electrically connected and configured to monitor an electrical parameter at the electrode. The grounding tube is aligned coaxially to the hole of the electrode, with an inward end of the tube proximate the electrode and an outward end of the tube distal the electrode. The grounding tube comprises an outer surface and an inner surface, the outer surface electrically connected to the system ground and electrically isolated from the electrode, the inner surface electrically isolated from the system ground and from the electrode. The case rigidly connects at least the electrode and the grounding tubes.

In aspects of the invention, a coating defect is detected on a catheter shaft by imposing an alternating voltage between an electrode and a grounding tube that is arranged coaxially with a hole through the electrode, passing the catheter shaft through the grounding tube and through the hole of the electrode, and monitoring the alternating voltage between the electrode and the grounding tube. The coating defect is detected, in case the amplitude of the monitored alternating voltage drops below a threshold value.

These and other objects, features and advantages of the present invention will become apparent in light of the detailed description thereof, as illustrated in the accompanying drawings.

### DRAWINGS

FIG. 1 shows a side section view of a catheter tester according to a first embodiment of the invention.

FIG. 2 shows a side section view of a test electrode housing of the tester shown in FIG. 1.

FIG. 3 shows a perspective view of the test electrode housing shown in FIG. 2.

FIG. 4 shows a voltage trace produced during testing of a catheter shaft using the tester shown in FIG. 1.

FIG. 5 shows a process for testing a catheter shaft using the tester shown in FIG. 1.

### DETAILED DESCRIPTION OF THE DRAWINGS

The drawings show an exemplary embodiment of the invention, which a skilled worker may vary or modify for particular applications according to ordinary knowledge.

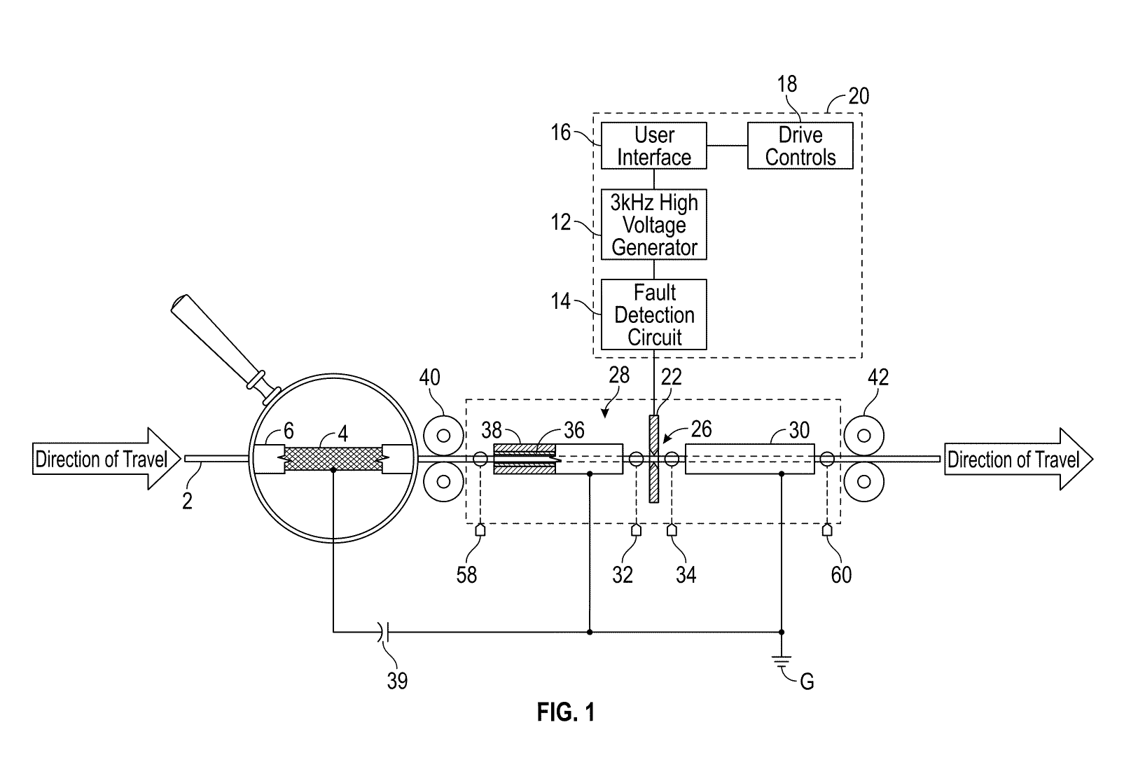

Referring to FIG. 1, a catheter shaft 2 includes a scaffold 4 that is encased by a polymer coating 6. The catheter shaft 2 is inserted into a catheter tester 10, according to a first embodiment of the invention. The catheter tester 10 includes voltage supply 12, fault detection circuitry 14, and a user interface 16 including drive controls 18. In some embodiments, as shown, the circuitry and user interface all are contained within a tester case 20. The voltage supply is connected via the fault detection circuitry to an annular electrode 22, mounted in an electrode housing 24. In some embodiments, the tester case 20 is integral with the electrode housing 24. In other embodiments, the tester case 20 can be discrete from the electrode housing 24, and the connection from the fault detection circuitry to the electrode can be made by flex leads.

The annular electrode 22 defines a test aperture 26, which is aligned with the openings of an infeed grounding tube 28 (at one end of the tester case 20) and an outfeed grounding tube 30 (at the other end of the tester case). Between the infeed grounding tube and the test aperture, an infeed electrode presence sensor 32 is provided. A similar outfeed electrode presence sensor 34 is provided between the test aperture and the outfeed grounding tube. The electrode presence sensors may include photoswitches, contact switches, Hall effect probes, or other sensors suitable for indicating presence or absence of a structure that is at least partially opaque and that includes a conductive element. The infeed and outfeed electrode presence sensors control test voltage application to avoid arcing as the cut ends of the catheter shaft approach the test aperture 26. In particular, the annular electrode 22 is energized only if both of the electrode presence sensors 32, 34 indicate the catheter shaft is present.

Each grounding tube includes a dielectric tube liner 36 and a conductive tube case 38, with each tube case being electrically connected to a system ground, while the dielectric tube liner 36 electrically isolates an inner surface of the grounding tube from the system ground. Thus, the catheter coating 6, the dielectric tube liner 36, and the conductive tube case 38 (as well as any air gap present between the catheter coating and the tube liner) present an equivalent capacitance 39 by which the catheter scaffold 4 is electrically connected to the system ground. The voltage supply 12 is likewise electrically connected to the system ground.

In this disclosure, “electrically connected” means, for example, a connection of less than X mΩ reactance; while “electrically isolated” means, for example, a connection on the order of greater than X MΩ reactance. Thus, electrical connection and isolation are in part a function of circuit frequency, and selection of an appropriate circuit frequency is one aspect of the invention.

For example, in a preferred embodiment, the voltage supply 12 is configured to provide relatively small current (e.g., no more than about 4 mA) at relatively high alternating voltage (e.g., about 3000-4000 VAC) and at a moderate driving frequency (e.g., about 3500 Hz, not less than about 3000 Hz, typically sine wave). Required test voltage is a function of the distance between the ID of the electrode and the OD of the product; a larger air gap requires a higher test voltage. Effective frequency of the supplied voltage (circuit frequency) is lower than the driving frequency, due to capacitive coupling from the electrode to system ground (frequency decay). Often, introduction of a properly coated catheter will produce a circuit frequency of about 3000 Hz from the driving frequency of about 3500 Hz. Very-high-capacitance products can drag circuit frequency even lower.

The tester case 20 also houses motor-driven infeed rollers 40 and outfeed rollers 42, which are controlled by the drive controls 18 to push and pull a catheter shaft into and out of the respective infeed and outfeed grounding tubes 28, 30.

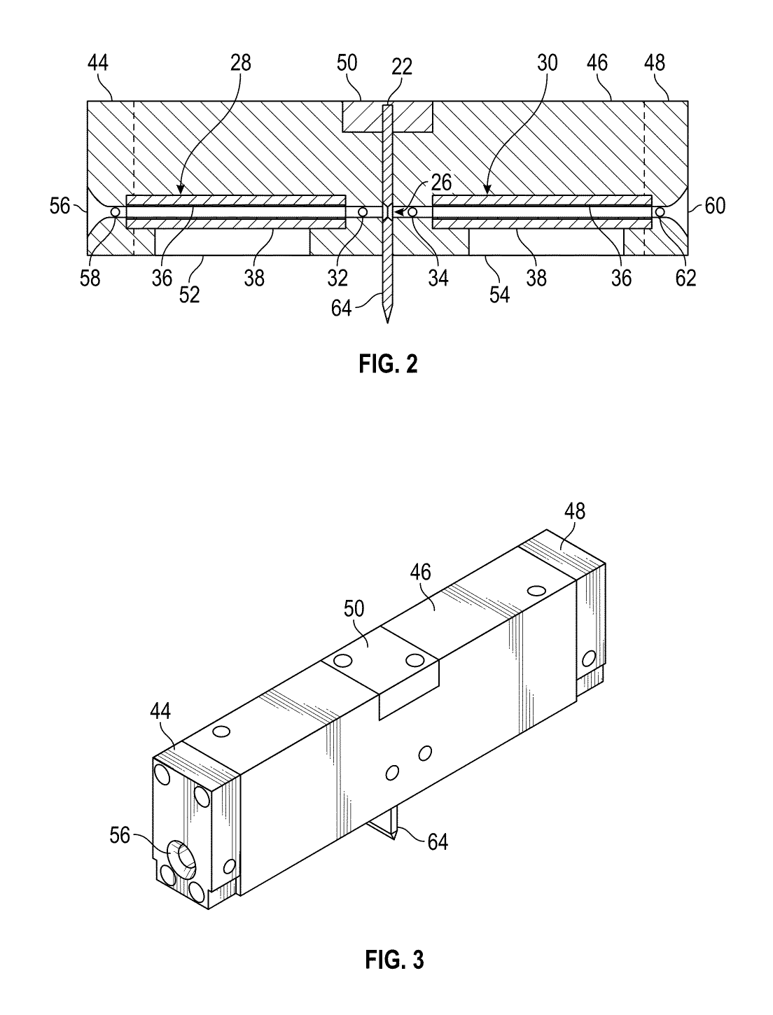

FIGS. 2 and 3 show detail of the electrode housing 24, which includes an infeed block 44, a main body 46, an outfeed block 48, and an electrode cap 50.

The grounding tubes 28, 30 are assembled into respective ends of the main body, which has access ports 52, 54 for electrically connecting the grounding tube cases 38 to the system ground G. Capacitive ground coupling of a catheter shaft to be tested, via the grounding tubes, suppresses induced voltage on a scaffold of the catheter shaft, thereby maintaining sufficient voltage differential between the scaffold and the electrode 22 in order to permit fault detection by capacitive charge transfer, as further discussed below.

The infeed block 44 and the outfeed block 46 are fastened to the ends of the main body to capture the grounding tubes 28, 30. Referring also to FIG. 1, the infeed block includes an infeed port 56 that is aligned with the infeed grounding tube 28 and includes an infeed roller presence sensor 58 (similar to either of the electrode presence sensors) that is electrically connected with the voltage supply 12 and with the drive controls. Similarly, the outfeed block includes an outfeed port 60 that is aligned with the outfeed grounding tube 30 and includes an outfeed roller presence sensor 62 that also is electrically connected with the voltage supply and with the drive controls. The infeed and outfeed roller presence sensors inform the voltage supply and the drive controls as to the location of a catheter shaft under test. In particular, while the infeed roller presence sensor is tripped, the infeed rollers 40 are driven, and while the outfeed roller presence sensor is tripped, the outfeed rollers 42 are driven.

The electrode cap 50, carrying the annular electrode 22, is fastened into the main body 46. The electrode protrudes from the cap through the main body and includes a spade portion 64, which can in some embodiments be electrically connected with the fault detection circuitry 14 by plugging into a spade clamp (not shown) that is mounted in the tester case 20.

The electrode housing 24 can be fabricated from any material or combination of materials, so long as the electrode 22 and the grounding tube cases 36 are electrically isolated from each other. The electrode and the grounding tube cases necessarily are manufactured of relatively conductive materials.

In operation, as shown in FIG. 1, the infeed rollers 40 grip and push the catheter shaft 2, which includes the polymer layer 6 coated onto the helical braid scaffold 4, into the infeed port 56. The infeed rollers push the shaft through the electrode housing until the outfeed rollers 42 grip and pull the shaft out from the outfeed port 60. As soon as a leading end of the catheter shaft trips the infeed roller presence sensor 58, the infeed electrode presence sensor 32, and the outfeed electrode presence sensor 32, the voltage supply 12 applies high voltage AC to the annular electrode 22.

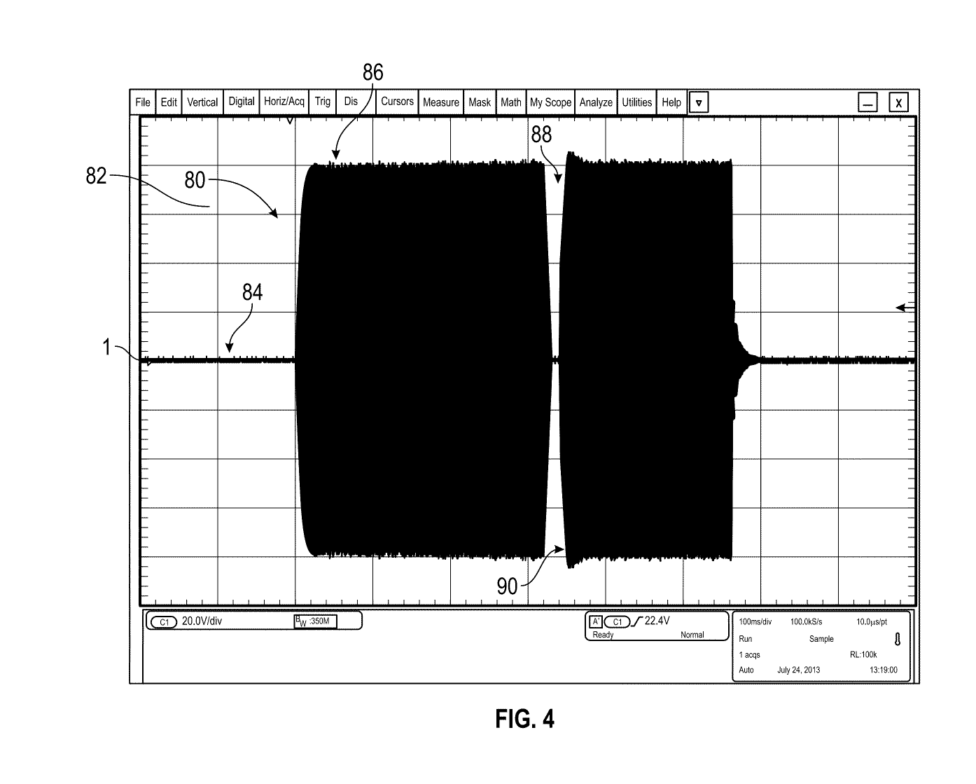

When high voltage alternating current is applied to the annular electrode 22, the electrode becomes capacitively coupled with the catheter shaft scaffold 4. The catheter shaft coating 6 isolates the scaffold both from the electrode 22 and from the grounding tubes 28, 30. Accordingly, capacitive coupling causes the catheter shaft scaffold 4 to gain an appreciable voltage, somewhere between ground voltage and the AC waveform of the annular electrode voltage. The voltage of the catheter shaft scaffold 4 will vary according to thickness and volumetric resistivity of the polymer coating 6, and according to the frequency of the AC voltage, between the annular electrode 22 and the catheter shaft scaffold. At high frequency and high capacitance, the inductance of the catheter shaft scaffold 4 will keep its induced voltage small, relative to the annular electrode voltage. That means that, in case of any perforation or other defect in the catheter shaft coating 6, there will be a significant voltage gap to cause a spark from the annular electrode 22 to the scaffold 4. Moreover, capacitive coupling of the catheter shaft scaffold 4 to the system ground means that while a coating defect is present under the annular electrode 22, the voltage of the annular electrode, as detected by the fault detection circuitry 14, will drop to match the scaffold voltage; this voltage drop will appear at the user interface 16 as a dip in the electrode voltage trace 82, as shown in FIG. 4.

The voltage supply 12 continues to apply high voltage to the annular electrode 22 until the trailing end of the catheter shaft has cleared the infeed roller presence sensor and the infeed electrode presence sensor. At this time the annular electrode voltage is interrupted, firstly to prevent arcing or sparking from the annular electrode to the exposed portions of the scaffold at the cut ends of the catheter, and secondly to avoid power draw for maintaining high voltage when no product is present to be tested.

While the voltage supply 12 is operative, the fault detect circuitry 14 senses the AC voltage 80 at the electrode. The sensed electrode voltage can in some embodiments be displayed on a trace 82 via the user interface 16. For example, as shown in FIG. 4, a typical voltage trace 82 includes an initial low reading segment 84 (before the leading end of the catheter shaft 2 has tripped the outfeed electrode presence sensor 32), followed by a high reading segment 86 while high voltage is applied.

In case of a fault in the polymer coating 6, capacitive transfer across the air gap from the electrode 22 to the catheter scaffold 4 produces a trace dip 88 that continues while the coating defect is exposed to the electrode. The length of the trace dip 88 is directly related to the size of the defect. The magnitude of the trace dip 88 also is related to the size and severity of the defect. Rejection criteria can be established, based on the trace dip 88 falling below a threshold value correlated to complete penetration of the catheter coating 6. An exemplary threshold value is a dip of more than 100 V below nominal amplitude.

The trace dip 88 is followed by a return 90 to high reading. The slope of the return 90 may be inversely related to the size of the defect; lengthier defects may produce a more gradual return, while smaller defects may provide a rapid return.

Once the catheter shaft trailing end clears the infeed electrode presence sensor 58, the trace drops back to a low reading as high voltage is interrupted. During operation, the grounding tubes 28, 30 provide for capacitive coupling of the catheter scaffold 4 back to system ground 38, so that when a coating fault crosses through the annular electrode 22, the catheter scaffold 4 does not simply match the electrode voltage.

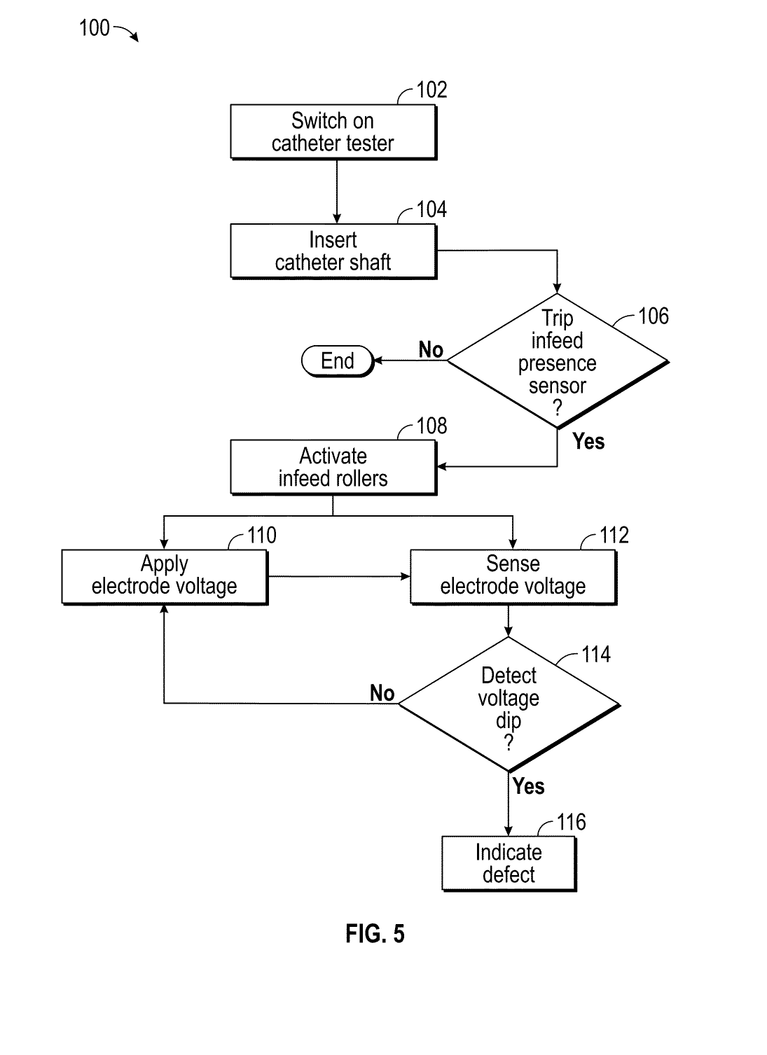

Thus, a process 100 for testing a cut-to-length catheter shaft, according to one aspect of the present invention, is shown at FIG. 5. First, a catheter tester is switched on 102. Next, a catheter shaft is inserted 104 between infeed rollers to trip 106 an infeed roller presence sensor. The infeed rollers are activated 108 to push the catheter shaft through an annular electrode. Meanwhile, high voltage is applied 110 to the annular electrode, and voltage at the annular electrode is sensed 112. In case a defect is present in the catheter shaft, a voltage dip is detected 114, and a defect indication is displayed 116. Whereas in the exemplary embodiment the defect indication is display of the trace dip 88 at the interface 16, other indications may appropriately be substituted or added, e.g., operation of a dump switch to discard the defective catheter shaft.

The invention has been described with respect to exemplary embodiments as shown in the attached drawings, and certain alternative embodiments have been expressly mentioned. Those skilled in the art will apprehend various further changes in form and detail consistent with the scope of the invention as defined by the appended claims.

What is claimed is:

1. A catheter coating fault detection apparatus comprising:
an electrode that has infeed and outfeed sides and that defines a hole, which opens from the infeed side to the outfeed side;
a voltage supply that is electrically connected to provide an alternating voltage between the electrode and a system ground;
a fault detection circuit that is electrically connected and configured to monitor an electrical parameter at the electrode;
a grounding tube aligned coaxially to the hole of the electrode, with an inward end of the tube proximate the electrode and an outward end of the tube distal the electrode,
the grounding tube comprising an outer surface and an inner surface, the outer surface electrically connected to the system ground and electrically isolated from the electrode, the inner surface electrically isolated from the system ground and from the electrode; and
a case that rigidly connects at least the electrode and the grounding tubes.

2. The apparatus as claimed in claim 1, further comprising an electrode presence sensor that is configured to actuate the voltage supply while a catheter shaft extends through the hole of the electrode.

3. The apparatus as claimed in claim 2, wherein the electrode presence sensor comprises a first sensor proximate the infeed side of the electrode, and a second sensor proximate the outfeed side of the electrode.

4. The apparatus as claimed in claim 1, further comprising rollers that are configured and positioned for driving a catheter shaft through the grounding tubes and through the hole of the electrode.

5. The apparatus as claimed in claim 4, further comprising a roller presence sensor that is configured to actuate the rollers while a catheter shaft extends through one of the grounding tubes adjacent the rollers.

6. The apparatus as claimed in claim 5, wherein the roller presence sensor comprises a first sensor proximate an outward end of the grounding tube at the infeed side of the electrode, and a second sensor proximate an outward end of a second grounding tube at the outfeed side of the electrode.

7. The apparatus as claimed in claim 1, further comprising a user interface that is configured to display data responsive to signals provided from the fault detection circuit.

8. The apparatus as claimed in claim 1, wherein the fault detection circuit monitors voltage between the electrode and the system ground.

9. The apparatus as claimed in claim 8, further comprising a user interface that is configured to display data responsive to signals provided from the fault detection circuit, wherein the data includes an electrode voltage trace.

10. The apparatus as claimed in claim 9, wherein the data includes a fault indication.

11. The apparatus as claimed in claim 10, wherein the fault indication includes a visible dip in an electrode voltage trace.

12. The apparatus as claimed in claim 10, wherein the fault indication includes a decrease of electrode voltage below a threshold value.

13. The apparatus as claimed in claim 1, wherein the voltage supply is configured to supply an alternating voltage of at least about 2500 V.

14. The apparatus as claimed in claim 1, wherein the voltage supply is configured to supply an alternating voltage of not more than about 4000 V.

15. The apparatus as claimed in claim 1, wherein the voltage supply is configured to supply an alternating voltage of at least about 3000 V.

16. The apparatus as claimed in claim 1, wherein a driving frequency of the voltage supply is at least 3 kHz.

17. The apparatus as claimed in claim 1, wherein a driving frequency of the voltage supply is about 3.5 kHz.

18. The apparatus as claimed in claim 1, wherein the voltage supply is configured to limit an electrode current to not exceed about 4 mA.

19. A method for detecting a coating defect on a catheter shaft, comprising:
imposing an alternating voltage between an electrode and a grounding tube that is arranged coaxially with a hole through the electrode;
passing the catheter shaft through the grounding tube and through the hole of the electrode;
monitoring the alternating voltage between the electrode and the grounding tube; and
detecting the coating defect, in case the amplitude of the monitored alternating voltage drops below a threshold value.

20. The method as claimed in claim 19, wherein the threshold value is 100 V less than a nominal amplitude of the monitored alternating voltage.
